(19) United States
(12) Patent Application Publication
(10) Pub. No.: US 2009/0019187 A1
(43) Pub. Date: Jan. 15, 2009

(54) Peripheral Device Using Method, and Peripheral Device Server

(76) Inventor: Keiji Okuma, Costa Mesa, CA (US)

Correspondence Address: OGILVIE LAW FIRM, 1320 EAST LAIRD AVENUE, SALT LAKE CITY, UT, 84105, US

(21) Appl. No.: 11/815,089

(22) PCT Filed: Jan. 30, 2006
(86) PCT No.: PCT/JP2006/301450

§ 371 Date: Jul. 30, 2007

(30) Foreign Application Priority Data
Feb. 2, 2005 (JP) 2005-025878

(51) Int. Cl. G06F 3/00

(52) U.S. Cl. 710/9

(57) ABSTRACT

A reservation managing device 3 stores a demand for using a peripheral device 20a, if made by a network computer (NC) 10a, in a reservation list. A peripheral device server 1 releases, in response to an ending command from an NC 10n having used the peripheral device 20a, the use of the peripheral device 20a by the NC 10n. The peripheral device server 1 receives the ending command and permits the NC 10a to use the peripheral device 20a with reference to the reservation list. The peripheral device server 1 receives the data to the peripheral device 20a from the NC 10a having permitted, and gives the data to the peripheral device 20a. The peripheral device server 1 releases, in response to the ending command from the NC 10a having used the peripheral device 20a, the use by the NC 10a. By performing the reservation management and the cutting management, another NC is enabled, quickly after the end of the use of the peripheral device, to use the peripheral device.

### CROSS-REFERENCE TO RELATED APPLICATION

The entire content of the disclosure including the specification, claims, drawings, and abstract of Japanese Patent Publication No. 2005-025878 (filed on Feb. 2, 2005) is incorporated in the present application.

### TECHNICAL FIELD

The present invention relates to peripheral device using methods, and in particular, to reservation management.

### BACKGROUND ART

Patent Document 1 discloses controlling an Universal Serial Bus (USB) device from a network client via a network by a peripheral device server to which the USB device is connected.

This specifically includes the following. Data to be transmitted to the USB device is encapsulated by a tunneling driver installed in the network client and is transmitted into on the network. The peripheral device server on a receiving side retrieves the data from a capsule, reconstructs the same, and transmits to the USB device. Data to be transmitted in the reverse direction is similarly encapsulated, and transmitted from the USB device to the network client. Thus, the USB device connected to the peripheral device server can be operated by the network client via the network. Thereby a user can use the USB device connected to the peripheral device server as if directly connected to the network client.

Patent Document 1: Specification of US Patent Publication No. 2002/0141418

### DISCLOSURE OF THE INVENTION

### Problem to be Solved by the Invention

However, the following problem arises when the above peripheral device is connected to the network client by way of the peripheral device server via the network.

While the network client is connected with the peripheral device such as USB device, the peripheral device is used exclusively by the relevant network client. Therefore, other network clients cannot use the peripheral device even after use of the relevant peripheral device is ended unless the network client disconnects the peripheral device. Furthermore, since other network clients are unable to know disconnection even in a case where the peripheral device has been disconnected without delay after the process is ended, a blank period is caused, and the device serving as a resource cannot be effectively utilized. Further, the network client that makes a connection request first after the disconnection acquires a next right of controlling the relevant peripheral device after the disconnection. Therefore the network client cannot use the relevant peripheral device until the timing of the connection request becomes right.

Such a problem arises not only with the USB device, but also with the peripheral device that cannot communicate with other computers once started to be used by a certain computer unless such use is released.

In view of overcoming the above problem, it is an object of the present invention to provide a peripheral device using method and a device for the same enabling effective use of the peripheral device that cannot communicate with other computers once started to be used by a certain computer unless such use is released.

### Means for Solving the Problem

1) A peripheral device using method according to the present invention is a peripheral device using method for a network computer connected via a network to a peripheral device server to use a peripheral device incapable of communicating, once started to be used by a network computer unless released, with another network computer, the method including: A) the peripheral device server storing a computer identifier of the network computer in a reservation list when a use request in which the connected peripheral device is specified is made from the network computer; B) the peripheral device server specifying a network computer of a high rank with reference to the reservation list, and permitting the network computer to start using the peripheral device; C) the permitted network computer starting data communication to the peripheral device; D) the peripheral device server providing received data for the peripheral device to the peripheral device; E) the peripheral device server transmitting the data received from the peripheral device to the permitted network computer, and the network computer receiving the data; F) the network computer transmitting an ending command to the peripheral device server when the data communication with the peripheral device is ended; G) the peripheral device server releasing use of the peripheral device by the network computer when receiving the ending command; and H) repeating B) to H) if a network computer that has not yet used is present in the reservation list. Through such reservation management and connection processes, exclusive use after the end of use is avoided even with the peripheral device incapable of communicating, once started to be used by a network computer unless released, with another network computer, and the connection process based on the reservation list can be carried out without causing a blank period.

2) A peripheral device server according to the present invention is a peripheral device server connected with a peripheral device incapable of communicating, once started to be used by a network computer unless released, with another network computer, the peripheral device server including: A) reservation managing means for storing a computer identifier of the network computer in a reservation list when a use request in which the connected peripheral device is specified is made from one of a plurality of network computers connected via a network; and B) connection managing means including, b1) releasing means for releasing use of the peripheral device by the network computer when receiving an ending command from the network computer having been using the peripheral device, b2) permitting means for determining whether or not a network computer that has not yet used the peripheral device is present in the reservation list when receiving the ending command, and if present, specifying a network computer of a high rank with reference to the reservation list and permitting the network computer to use the peripheral device, and b3) data communicating means for receiving data for the peripheral device from the permitted network computer and providing the data to the peripheral device. Through such reservation management and connection processes, exclusive use after the end of use is avoided even with the peripheral device incapable of communicating, once started to be used by a network computer unless released, with another network computer, and the connection process based on the reservation list can be carried out without causing a blank period.

3) A peripheral device server according to the present invention is a peripheral device server connected with a peripheral device incapable of communicating, once started to be used by a network computer unless released, with another network computer, the peripheral device server including: A) reservation managing means for storing a computer identifier of the network computer in a reservation list when a use request in which the connected peripheral device is specified is made from one of a plurality of network computers connected via a network; and B) connection managing means including, b1) permitting means for specifying a network computer of a high rank with reference to the reservation list, and permitting the network computer to start using the peripheral device, b2) data communicating means for receiving data for the peripheral device from the permitted network computer and providing the data to the peripheral device, and b3) releasing means for releasing use of the peripheral device by the network computer when receiving an ending command from the network computer. Through such reservation management and connection processes, exclusive use after the end of use is avoided even with the peripheral device incapable of communicating, once started to be used by a network computer unless released, with another network computer, and the connection process based on the reservation list can be carried out without causing a blank period.

4) In the peripheral device server according to the present invention, the data communicating means transmits data from the network computer to the peripheral device. Therefore, exclusive use after the end of use is avoided and a connection process based on the reservation list can be carried out without causing a blank period in the peripheral device for outputting data to the peripheral device.

5) In the peripheral device server according to the present invention, the data communicating means transmits data from the peripheral device to the network computer. Therefore, exclusive use after the end of use is avoided and a connection process based on the reservation list can be carried out without causing a blank period in the peripheral device for receiving data from the peripheral device.

6) A peripheral device server according to the present invention is a peripheral device server connected with a peripheral device incapable of communicating, once started to be used by a network computer unless released, with another network computer, the peripheral device server performing: storing a computer identifier of the network computer when a use request in which the connected peripheral device is specified is made from one of a plurality of network computers connected via a network; permitting the network computer to use the peripheral device when use of the peripheral device by another network computer of a higher rank than the network computer in the reservation list is ended; and receiving data for the peripheral device from the permitted network computer and providing the data to the peripheral device. Through such reservation management and connection processes, exclusive use after the end of use is avoided even with the peripheral device incapable of communicating, once started to be used by a network computer unless released, with another network computer, and the connection process based on the reservation list can be carried out without causing a blank period.

7) A peripheral device server according to the present invention is a peripheral device server connected with a peripheral device incapable of communicating, once started to be used by a network computer unless released, with another network computer; the peripheral device server performing: determining whether or not the peripheral device is being used by another network computer when a use request in which the connected peripheral device is specified is made from one of a plurality of network computers connected via a network, and if being used, waiting the network computer; permitting the network computer having made the use request to use the peripheral device when use by the another network computer in use is ended; and receiving data for the peripheral device from the permitted network computer and providing the data to the peripheral device. Through such waiting process and permission of use, exclusive use after the end of use is avoided even with the peripheral device incapable of communicating, once started to be used by a network computer unless released, with another network computer, and use thereof becomes possible without causing a blank period.

8) A peripheral device server according to the present invention is a network computer connected via a network to a peripheral device server to be connected with a peripheral device incapable of communicating, once started to be used by a network computer unless released, with another network computer; the network computer including: 1) reservation proposing means for making a use reservation on the peripheral device connected to the peripheral device server; 2) using means for, when receiving a notification that use is possible, transmitting data for the peripheral device and starting to use the peripheral device; and 3) end commanding means for transmitting an ending command to the peripheral device server to release use of the peripheral device by the network computer when use of the peripheral device is ended. Through such reservation proposing, use starting, and releasing processes, exclusive use after the end of use is avoided even with the peripheral device incapable of communicating, once started to be used by a network computer unless released, with another network computer, and efficient use is achieved without causing a blank period.

9) A program according to the present invention is a program for a peripheral device server connected with a peripheral device incapable of communicating, once started to be used by a network computer unless released, with another network computer, the program for making the peripheral device server to execute processes of: 1) storing a computer identifier of the network computer in a reservation list when a use request in which the connected peripheral device is specified is made from one of a plurality of network computers connected via a network; 2) specifying a network computer of a high rank with reference to the reservation list when a network computer having not yet used is present in the reservation list, and permitting the network computer to use the peripheral device; 3) receiving data for the peripheral device from the permitted network computer and providing the data to the peripheral device; and 4) releasing use of the peripheral device by the network computer when receiving an ending command from the network computer. Through such reservation management and connection processes, exclusive use after the end of use is avoided even with the peripheral device incapable of communicating, once started to be used by a network computer unless released, with another network computer, and connection process based on the reservation list can be carried out without causing a blank period.

10) A program according to the present invention is a program for a network computer to execute processes with a peripheral device server connected with a peripheral device incapable of communicating, once started to be used by a network computer unless released, with another network computer, the program for making the peripheral device server to executed the processes of: 1) making a use reservation for the peripheral device connected to the peripheral device server; 2) transmitting data for the peripheral device when receiving a notification that use is possible, and starting to use the peripheral device; and 3) transmitting an ending command to the peripheral device server to release use of the peripheral device by the network computer when use of the peripheral device is ended. Through such reservation management and connection processes, exclusive use after the end of use is avoided even with the peripheral device incapable of communicating, once started to be used by a network computer unless released, with another network computer, and the connection process based on the reservation list can be carried out without causing a blank period.

11) A method of using a peripheral device server according to the present invention is a method of using a peripheral device server connected with a peripheral device incapable of communicating, once started to be used by a network computer unless released, with another network computer, the method including: 1) storing a computer identifier of the network computer in a reservation list when a use request in which the connected peripheral device is specified is made from one of a plurality of network computers connected via a network; 2) specifying a network computer of a high rank with reference to the reservation list when a network computer that has not yet used is present in the reservation list, and permitting the network computer to use the peripheral device; 3) receiving data for the peripheral device from the permitted network computer and providing the data to the peripheral device; and 4) releasing use of the peripheral device by the network computer when receiving an ending command from the network computer. Through such reservation management and connection processes, exclusive use after the end of use is avoided even with the peripheral device incapable of communicating, once started to be used by a network computer unless released, with another network computer, and the connection process based on the reservation list can be carried out without causing a blank period.

12) A method of using a peripheral device server according to the present invention a method of using a peripheral device server connected with a peripheral device incapable of communicating, once started to be used by a network computer unless released, with another network computer, the method including: 1) making a use reservation for the peripheral device connected to the peripheral device server; 2) transmitting data for the peripheral device when receiving a notification that use is possible, and starting to use the peripheral device; and 3) transmitting an ending command to the peripheral device server to release se of the peripheral device by the network computer when use of the peripheral device is ended. Through such reservation management and connection processes, exclusive use after the end of use is avoided even with the peripheral device incapable of communicating, once started to be used by a network computer unless released, with another network computer, and connection process based on the reservation list can be carried out without causing a blank period.

13) A method of using a peripheral device according to the present invention is a method of using a peripheral device by a network computer, for allowing a plurality of network computers connected via a network to access a peripheral device server connected with peripheral devices, and transmit and receive data with one of the peripheral devices, the method characterized by: 1) the peripheral device being unable to communicate, once started to be used by a network computer unless released, with another network computer, the method including: 2) storing a computer identifier and a rank in the peripheral device server of a network computer that has made a use request in which one of the peripheral devices is specified; 3) transmitting data for the peripheral device via the peripheral device server when use of the peripheral device by a network computer of a higher rank is ended and use of the peripheral device is permitted; and 4) providing an ending command when data transmission to the peripheral device is ended, and releasing use of the peripheral device by the network computer. Therefore, when the computer identifier and the rank are stored, and use of the peripheral device is permitted after use of the peripheral device by the network computer of a higher rank is ended, exclusive use after the end of use is avoided even with the peripheral device incapable of communicating, once started to be used by a network computer unless released, with another network computer, and an efficient connection process can be carried out without causing a blank period.

14) A peripheral device server according to the present invention is a peripheral device server connected with the peripheral device, wherein the peripheral device is configured as an assembly of a plurality of peripheral device parts; each of the peripheral device parts is configured unable to communicate, once started to be used by a network computer unless released, with another network computer; and the peripheral device server includes the following means. A) reservation managing means for storing a computer identifier of the network computer in a reservation list for all the peripheral device parts configuring the peripheral device that has made a use request when the use request in which the connected peripheral device is specified is made from one of a plurality of network computers connected via a network; and B) connection managing means including b1) releasing means for releasing use of all the peripheral device parts by the network computer when receiving an ending command from the network computer that has been using the peripheral device, b2) permitting means for determining whether or not a network computer that has not yet used the peripheral device is present in the reservation list when receiving the ending command, and if present, specifying a network computer of a high rank with reference to the reservation list, and permitting the network computer to use all the peripheral device parts of the peripheral device, and b3) data communicating means for providing, when receiving data for one or more peripheral device parts of the peripheral device from the permitted network computer, the data to the peripheral device.

Through such reservation management and connection processes as the peripheral device as a whole, exclusive use after the end of use is avoided even with the peripheral device incapable of communicating, once started to be used by a network computer unless released, with another network computer and configured by a plurality of peripheral device parts, and the connection process based on the reservation list can be carried out without causing a blank period.

15) A peripheral device server according to the present invention is a peripheral device server connected with the peripheral device wherein the peripheral device is configured as an assembly of a plurality of peripheral device parts; each of the peripheral device parts is configured unable to communicate, once started to be used by a network computer unless released, with another network computer; and the peripheral device server includes the following means. A) reservation managing means for storing a computer identifier of the network computer in a reservation list for all the peripheral device parts configuring the peripheral device that has made a use request when the use request in which the connected peripheral device is specified is made from one of a plurality of network computers connected via a network; and B) connection managing means including b1) permitting means for specifying a network computer of a high rank with reference to the reservation list, and permitting the network computer to use all the peripheral device parts of the peripheral device, b2) data communicating means for, receiving data for one or more peripheral device parts of the peripheral device from the permitted network computer, and providing the data to the peripheral device; and b3) releasing means for releasing use of all the peripheral device parts by the network computer when receiving an ending command from the network computer.

Through such reservation management and connection processes as the peripheral device as a whole, exclusive use after the end of use is avoided even with the peripheral device incapable of communicating, once started to be used by a network computer unless released, with another network computer and configured by a plurality of peripheral device parts, and the connection process based on the reservation list can be carried out without causing a blank period.

16) A data outputting method according to the present invention is a data outputting method of: connecting a peripheral device incapable of communicating, once started to be used by a network computer unless released, with another network computer to a peripheral device server, connecting the peripheral device server and a plurality of network computers via a network, and outputting data from one of the network computers to the peripheral device; wherein 1) the network computer that has made a use request in which the connected peripheral device is specified monitors whether or not data for the peripheral device is present in a temporary storage region for temporarily storing data converted to data for the specified peripheral device, and if present, stores a computer identifier of the network computer in a reservation list of the peripheral device server; 2) the peripheral device server references the reservation list and permits the network computer that has made the use request to use the peripheral device when a connecting rank of the network computer that has made the use request is reached; and 3) the permitted network computer outputs the converted data stored in the temporary storage region to the peripheral device.

Therefore, exclusive use after the end of use is avoided even with the peripheral device incapable of communicating, once started to be used by a network computer unless released, with another network computer, and a efficient connection process can be carried out without causing a blank period. Moreover, the network computer can output data to the peripheral device when the connection rank thereof comes by simply specifying the peripheral device to which the request for use is made.

18) In the data outputting method according to the present invention, the network computer makes a disconnection request to the peripheral device server after outputting all the converted data for the peripheral device stored in the temporary storage region to the peripheral device; and the peripheral device server releases use of the peripheral device by the network computer when receiving the disconnection request. Therefore, the peripheral device can be released after use is ended.

In the present specification, “high rank” refers to an earliest time of connection requests in the embodiment, but is not limited thereto, and also includes the concept of setting priorities and ranking based on the priority becomes higher. “Reservation list” corresponds to the connection request list in the embodiment. “Network computer” corresponds to network clients 10a to 10n in the embodiment.

The features, other objects, applications, and effects of the present invention should become apparent from the following embodiments with reference to the drawings.

### BRIEF DESCRIPTION OF THE DRAWINGS

FIG. 1 is a schematic view of a peripheral device using system 21 according to the present invention.

FIG. 2 is a functional block diagram of the peripheral device using system 21 according to the present invention.

FIG. 3 is a view showing an example of a hardware construction in which a peripheral device server 1 shown in FIG. 2 is realized using a CPU.

FIG. 4 is a view showing a relationship among various programs stored in a non-volatile memory 26.

FIG. 5 is a view showing an information table for connected peripheral devices.

FIG. 6 is a view showing a data structure of a connection request list.

FIG. 7 is a view showing an example of a hardware construction in which a network client 10n shown in FIG. 2 is realized using the CPU.

FIG. 8 is a view showing relationships among various programs stored in a hard disc 126.

FIG. 9 is a view (schematically) showing a flow of a reservation process between the network client and the peripheral device server.

FIG. 10 is a view showing relationships among respective programs.

FIG. 11 is a flow chart of a connecting and disconnection process based on reservations.

FIG. 12 is a view showing relationships among respective programs when a SPOOL is arranged.

FIG. 13 is a view showing an entire configuration when a multifunction peripheral is connected.

FIG. 14 is a view showing the information table for the connected peripheral devices.

### DESCRIPTION OF SYMBOLS

1 peripheral device server
10a to 10n network client
20a to 20n peripheral device

### BEST MODE FOR CARRYING OUT THE INVENTION

1. Outline

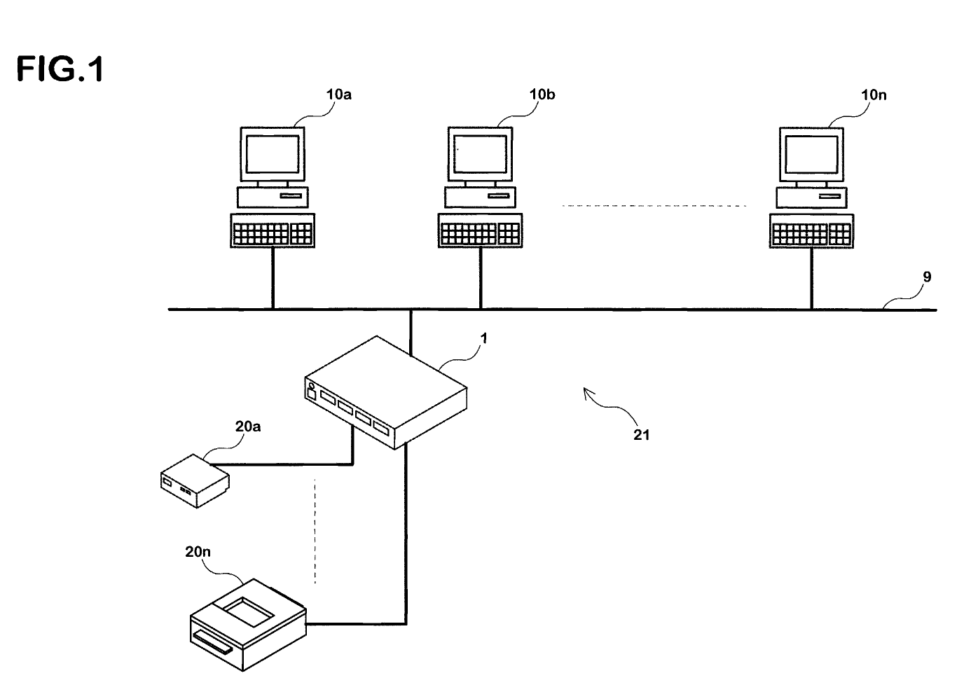

One embodiment of the present invention is now described based on the drawings. A peripheral device using system 21 shown in FIG. 1 includes a plurality of network clients 10a to 10n, a plurality of peripheral devices 20a to 20n, and a peripheral device server 1.

The peripheral device server 1 is connected to each of the network clients 10a to 10n by way of a network 9. The peripheral devices 20a to 20n, which cannot communicate with other network clients once started to be used by a certain network client unless such use is released, are connected to the peripheral device server 1.

The peripheral device using system 21 performs use reservation management and connection management on a desired peripheral device provided from one of the plurality of network clients 10a to 10n, as hereinafter described.

2. Description of Functional Block Diagram

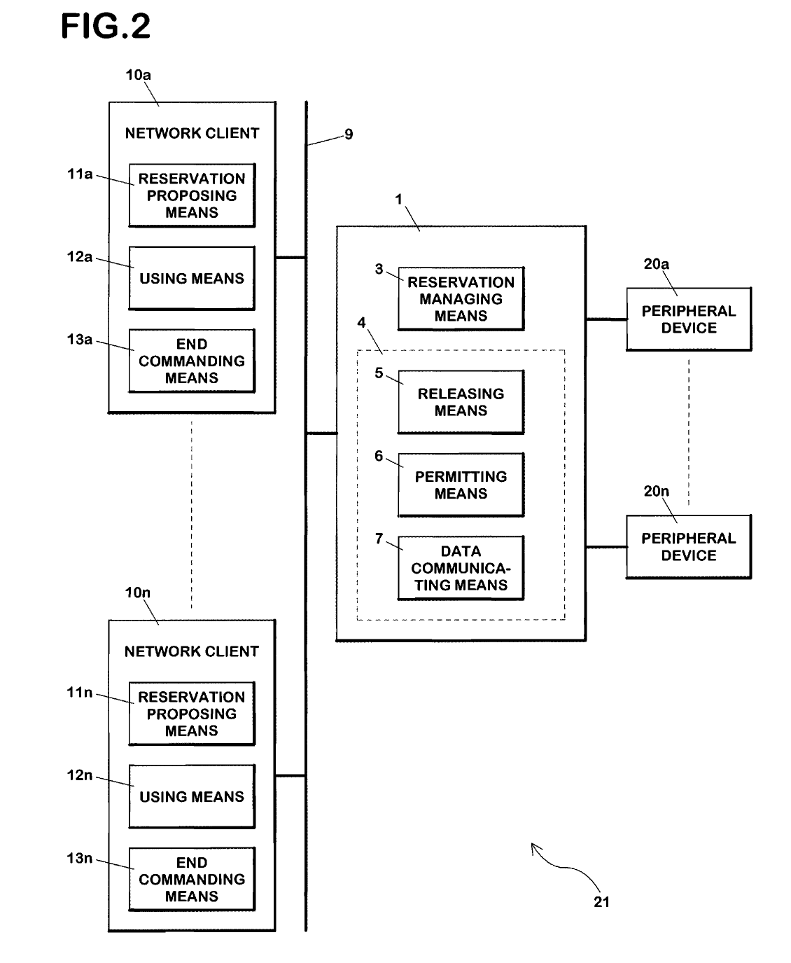

The network clients and the peripheral device server 1 shown in FIG. 1 are described with reference to FIG. 2. The network client 10a includes a reservation proposing means 11a, a using means 12a, and an end commanding means 13a. The other network clients have the same configuration. The peripheral device server 1 includes a reservation managing means 3, and a connection managing means 4. The connection managing means 4 includes a releasing means 5, a permitting means 6, and a data communicating means 7.

The use reservation management and connection management of the peripheral device 20a with respect to the network client 10a is described below.

The reservation proposing means 11a of the network client 10a makes a reservation to use the peripheral device 20a connected to the peripheral device server 1 based on an operation by an operator (user). If a use request specifying the connected peripheral device is made from one of the plurality of network clients connected to the network, the reservation managing means 3 of the peripheral device server 1 stores a computer identifier of the relevant network client. In this case, the computer identifier of the network client 10a is stored in a reservation list for the peripheral device 20a.

The releasing means 5 of the peripheral device server 1 releases use of the peripheral device 20a by the network client when receiving an ending command from the network client having used the peripheral device 20a. After receiving the ending command, the permitting means 6 determines whether or not a network client that has not used the peripheral device 20a is present in the reservation list, and if present, specifies the network client of a high rank with reference to the reservation list, and permits use of the peripheral device to the network client. Since the network client of the high rank is the network client 10a in this case, the network client 10a is permitted.

When receiving a notification that use is permitted, the using means 12a of the network client 10a starts to communicate with the peripheral device server 1, and starts to use the peripheral device 20a. When receiving data for the peripheral device 20a from the permitted network client 10a, the data communicating means 7 of the peripheral device server 1 provides the data to the peripheral device 20a. When receiving the data from the peripheral device 20a, the data communicating means 7 of the peripheral device server 1 transmits the data to the using means 12a of the network client 10a. Data transmission thus can be carried out between the network client 10a and the peripheral device 20a.

When the use of the peripheral device 20a is ended, the end commanding means 13a of the network client 10a transmits an ending command to the peripheral device server 1 so that the use of the peripheral device 20a by the network client 10a is released.

Thus, the use request is temporarily stored in the reservation list when the request is made and the peripheral device is used according to the reservation list when the peripheral device becomes available, and connection is cut off after the use is ended. Therefore, a blank time is not caused, and the peripheral device can be used in order of descending rank.

3. Configuration of Peripheral Device Server

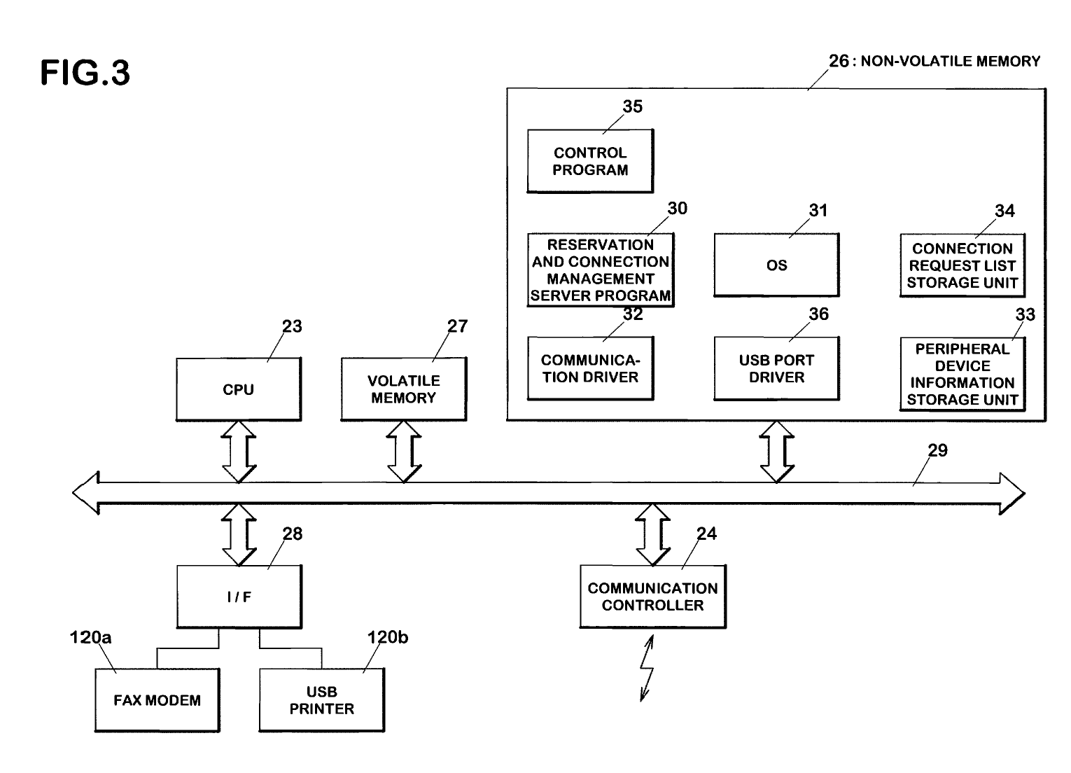

A hardware construction of the peripheral device server 1 shown in FIG. 2 is now described with reference to FIG. 3. FIG. 3 is an example of a configuration of the peripheral device server 1 with using a CPU.

The peripheral device server 1 includes a CPU 23, a volatile memory 27, a non-volatile memory 26, an interface (I/F) 28, a communication controller 24, and a bus line 29. The CPU 23 controls each unit via the bus line 29 according to program stored in the non-volatile memory 26.

One or more peripheral devices are connected to the interface 28. In this example, a FAX modem 120a and a USB printer 120b are connected as the peripheral devices. The communication controller 24 performs data communication with the network client connected to the network.

An operation system program (hereinafter abbreviated as OS) 31, a reservation and connection management server program 30, a communication driver 32, a control program 35, and a USB port driver 36 are stored in the non-volatile memory 26.

As hereinafter described, the control program 35 is responsible for overall processes such as communication and interaction with the peripheral device, and the USB port driver 36 manages the entire USB communication and USB logic ports. The communication driver 32 performs, as described below, a process of providing data provided from the network clients 10a to 10n via the communication controller 24 shown in FIG. 3 to the FAX modem 120a and the USB printer 120b, and a process of providing the data provided from the FAX modem 120a and the USB printer 120b to the network clients 10a to 10n via the communication controller 24.

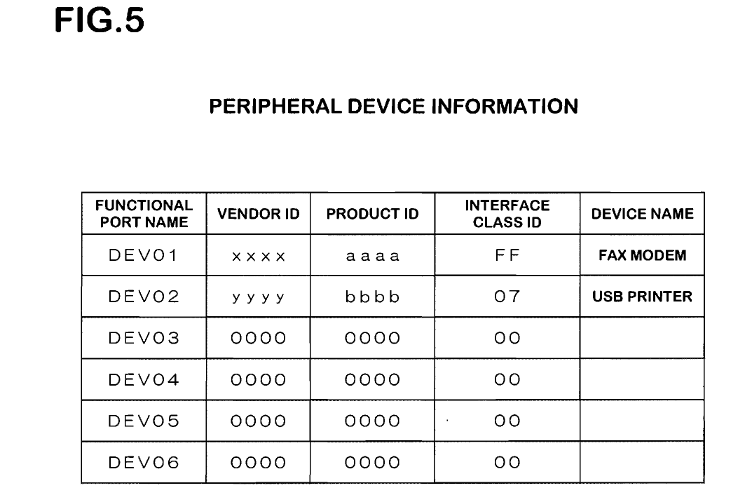

The non-volatile memory 26 also includes a peripheral device information storage unit 33 and a connection request list storage unit 34. Peripheral device information stored in the peripheral device information storage unit 33 is described with reference to FIG. 5. As shown in FIG. 5, a functional port name, a vendor ID, a product ID, an interface class ID, and a device name are stored for each peripheral device connected to the peripheral device server 1 for every logic port. In the present embodiment, a peripheral device having a vendor ID “xxxx”, a product ID “aaaa”, an interface class ID “FF” and a device name “FAX modem” is connected to the functional port “DE01”, and a peripheral device having a vendor ID “yyyy”, a product ID “bbbb”, an interface class ID “07” and a device name “USB printer” is connected to a functional port “DEV02”. No peripheral devices are connected to remaining functional ports “DEV03” to “DEV06”.

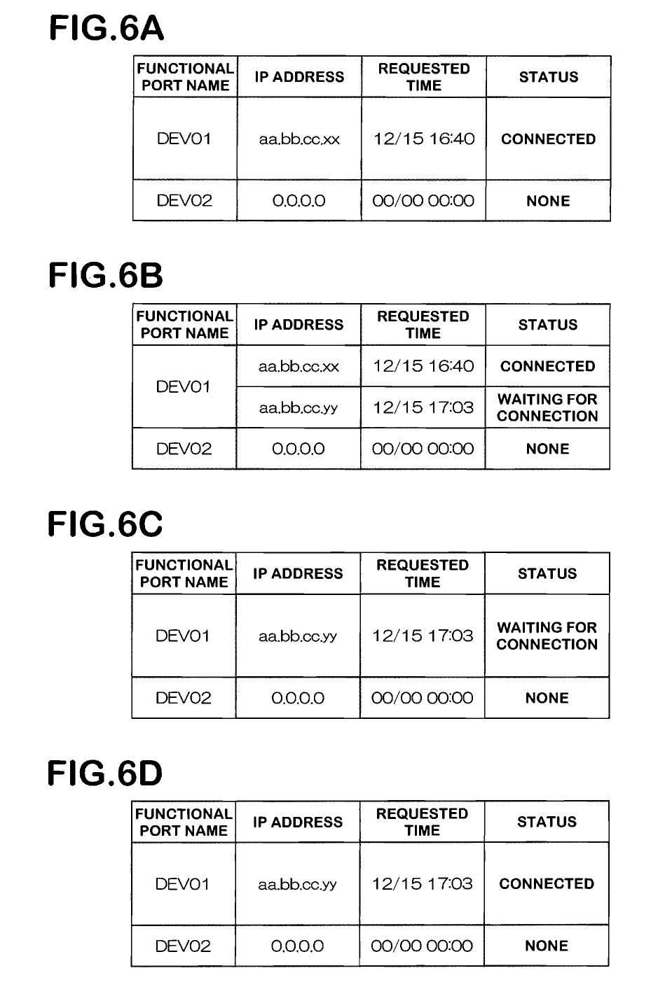

A connection request list stored in the connection request list storage unit 34 is described with reference to FIG. 6. As shown in FIG. 6A, an IP address, a connection requested time, and a status of a network client that has made the connection request are stored for every functional port in the connection request list.

In FIG. 6A, the request from the network client having an IP address “aa.bb.cc.xx” was made on “12/15, 16:40” for the functional port “DEV01”, and the current status is “connected”. No network client in a current status of “connected” or “waiting for connection” is found for the functional port “DEV02”.

In the present embodiment, reference can be made to FIG. 5 regarding which peripheral device is connected to which functional port, and thus a reservation status is stored for each peripheral device by the connection request list and the peripheral device information. For instance, according to FIG. 6B, since the network clients that are currently connected and waiting for connection are found for the port “DEV01” and the FAX modem 120a is connected to the port “DEV01”, and thus it is found that the network clients that are currently connected and waiting for connection exist for the FAX modem 120a.

A Linux (registered trademark) embedded real time OS is used for the OS 31 in the present embodiment. However, the present invention is not limited to such an OS, and can be executed on various OS.

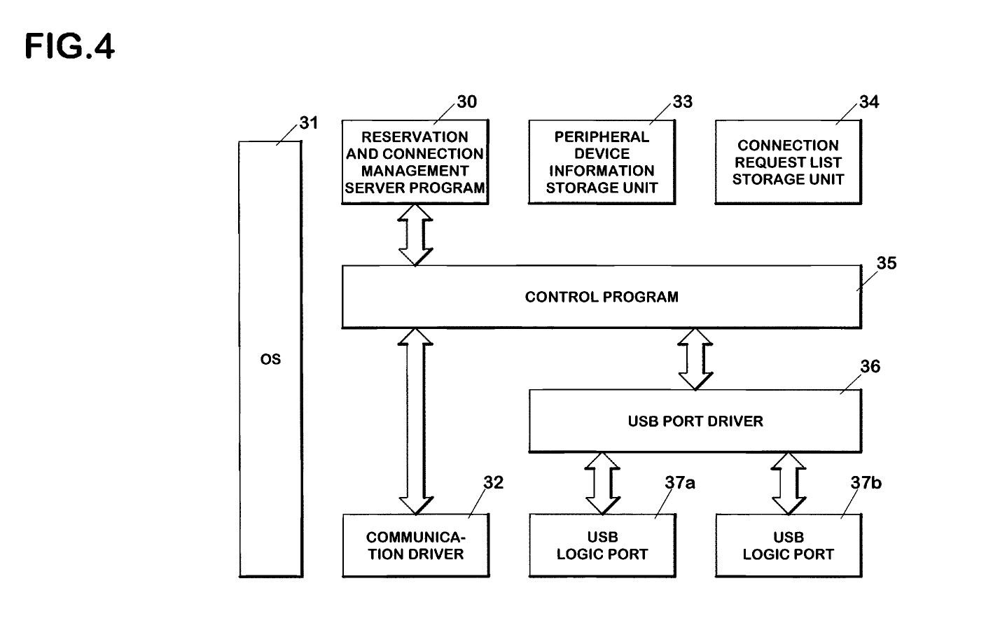

The relationship among various programs, drivers, and the like stored in the non-volatile memory 26 is as shown in FIG. 4. A software construction shown in FIG. 4 is one example for describing the present embodiment, and is not limited thereto. The relationship among the communication driver 32, the control program 35, the reservation and connection management server program 30, and the USB port driver 36 is described later.

The USB port driver 36 includes USB logic ports 37a, 37b for the FAX modem 120a and the USB printer 120b, respectively, in the present embodiment. A plurality of logic ports is not necessarily required, and a single port may be provided.

The relationship between the functional port names DEV01 to 06 of FIG. 5 and the logic ports of FIG. 4 is described. The logic ports USB 37a, 37b are port drivers provided respectively for each USB physical I/F port. On the other hand, the functional port names DEV01 to 06 are provided respectively for each function of the connected peripheral device. If a multi-function printer and the like, for example, having four functions of a printer, a scanner, a FAX, and a storage is connected, one logic port (e.g., USB 37a) performs control since the number of peripheral device is one. Nevertheless even if the peripheral device is physically one and connected through USB port, functional ports are managed respectively such that DEV01 is a functional port for the printer, DEV02 for the scanner, DEV03 for the FAX, and DEV04 for the storage.

4. Configuration of Network Client

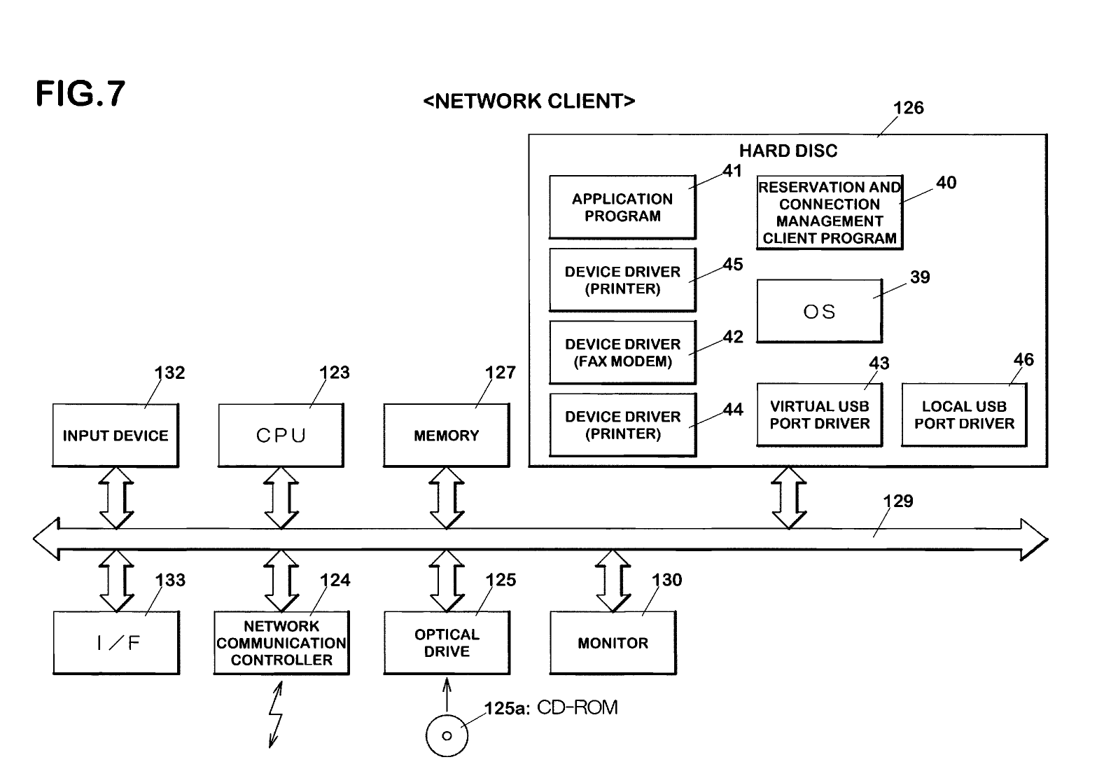

A hardware construction of the network client 10a shown in FIG. 2 is described with reference to FIG. 7. The network client 10a is a general personal computer that includes a CPU 123, a memory 127, a hard disc 126, a monitor 130 serving as a display device, an input device 132 such as a keyboard and a mouse, an optical drive 125 such as a CD/DVD drive, a network communication controller 124, an external I/F 133 such as a USB/IEEE1394/parallel/serial, and a bus line 129, as shown in FIG. 7. The CPU 123 controls each unit via the bus line 129 according to each program stored in the hard disc 126. The network communication controller 124 performs data communication with the peripheral device server 1 connected to the network.

The hard disc 126 includes an OS 39, a reservation and connection management client program 40, an application program 41, device drivers 42, 44, 45, a virtual USB port driver 43, and a local USB port driver 46.

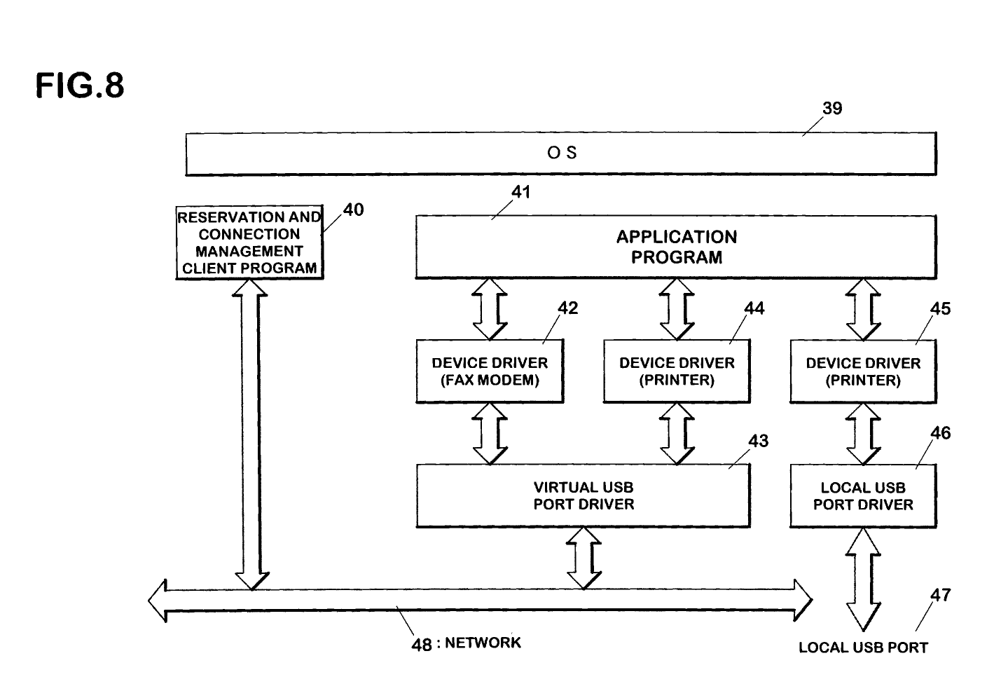

The relationship between the programs and the drivers stored in the hard disc 126 is described with reference to FIG. 8.

Windows XP (Registered trademark) of Microsoft Co., is used for the OS 39 in the present embodiment, but is not limited thereto.

The application program 41 is a general application software which is capable of performing operations of the FAX modem and the printer. The reservation and connection management client program 40 selects the peripheral device connected to the peripheral device server 1 and performs the processes of a connection request, a disconnection request, and the like, as hereinafter described.

The device drivers 42, 44 are device drivers for the peripheral devices connected to the peripheral device server 1. In the present embodiment, the USB device driver for the FAX modem 120a shown in FIG. 3 corresponds to the device driver 42, and the USB device driver for the USB printer 120b corresponds to the device driver 44.

The virtual USB port driver 43 is positioned between the device drivers 42, 44 and a network 48, and can treat the peripheral device connected to the peripheral device server 1 as if directly connected to the local USB port of the network client itself by communicating with the communication driver of the peripheral device server 1 as described below.

On the other hand, the device driver 45 is connected to the local USB port 47 by way of the local USB port driver 46. Through this local USB port driver 46, data can be transferred to the printer connected to the local USB port 47.

When a printer same as the USB printer 120b connected to the peripheral device server 1 is connected to the local USB port 47, the same device driver needs to be installed in the network client. If a plurality of peripheral devices are present, the device driver is required for each peripheral device even if the device driver is the same since the device driver can only be linked to one port.

In the present embodiment, the each program is installed in the hard disc via the optical drive 125, and the program is loaded in the volatile memory by OS and operated as necessary. Other than the optical drive, a program may be installed in the hard disc from a computer readable computer medium such as a flexible disc (FD) and an IC card. Furthermore, the program may be loaded in the volatile memory directly from the optical drive without using the hard disc at all, may be installed in the non-volatile memory such as a flash memory, or may be downloaded using a communication line. The program is developed in the volatile memory in execution, but may be executed directly on the non-volatile memory such as the flash memory, or may be executed in another computer through the communication line as in a remote procedure call. The program executable by the computer is not limited thereto, and also includes a program that can be installed as it is and directly executed, a program that needs to be converted once to another form (e.g., decompressing compressed data), and a program executable in combination with another module portion.

The above are merely examples and the hardware construction is not limited thereto. The other network clients shown in FIG. 2 have substantially the same hardware construction as the network client 10a. Regarding the other network clients, a program desired to be processed by the relevant network client is installed as the application program, and other application programs may obviously be installed.

5. Reservation and Connection Process

The reservation and connection process between the peripheral device server 1 and the network clients 10a to 10n is now described. In the following, a case where a connection request for the FAX modem 120a is made to the peripheral device server 1 by the network client 10n having an IP address “aa.bb.cc.yy” while the FAX modem 120a connected to the port DEV01 is being used by the network client having the IP address “aa.bb.cc.xx” is described.

### 5.1 Reservation Process

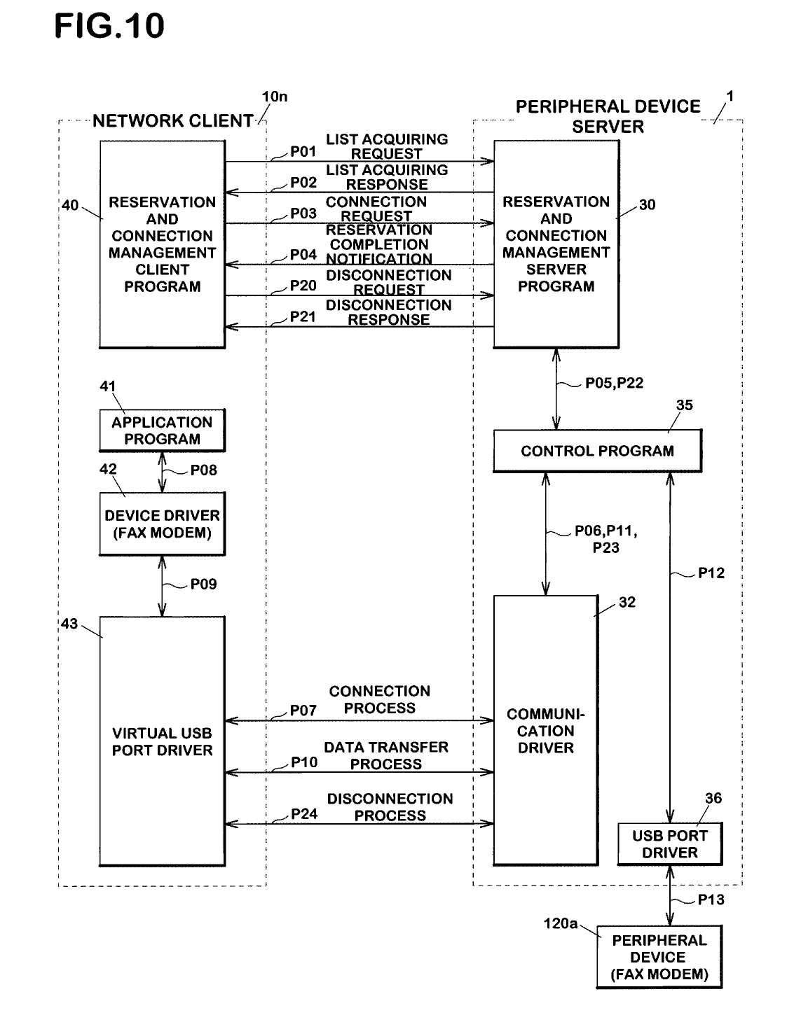

The outline of the reservation process by the reservation connection management server program 30 (hereinafter referred to as server program 30) of the peripheral device server 1 and the reservation connection management client program 40 (hereinafter referred to as client program 40) of the network clients 10a to 10n is described below with reference to FIG. 10.

The client program 40 of the network client 10n makes a request for a list of connected peripheral devices to the peripheral device server 1 (process P01). In response, the server program 30 of the peripheral device server 1 sends the peripheral device list (process P02). The client program 40 makes a connection request for the selected peripheral device based on the selection made by the operator (user) (process P03). The server program 30 reserves the peripheral device specified in the connection request, and transmits a reservation completion notification (process P04).

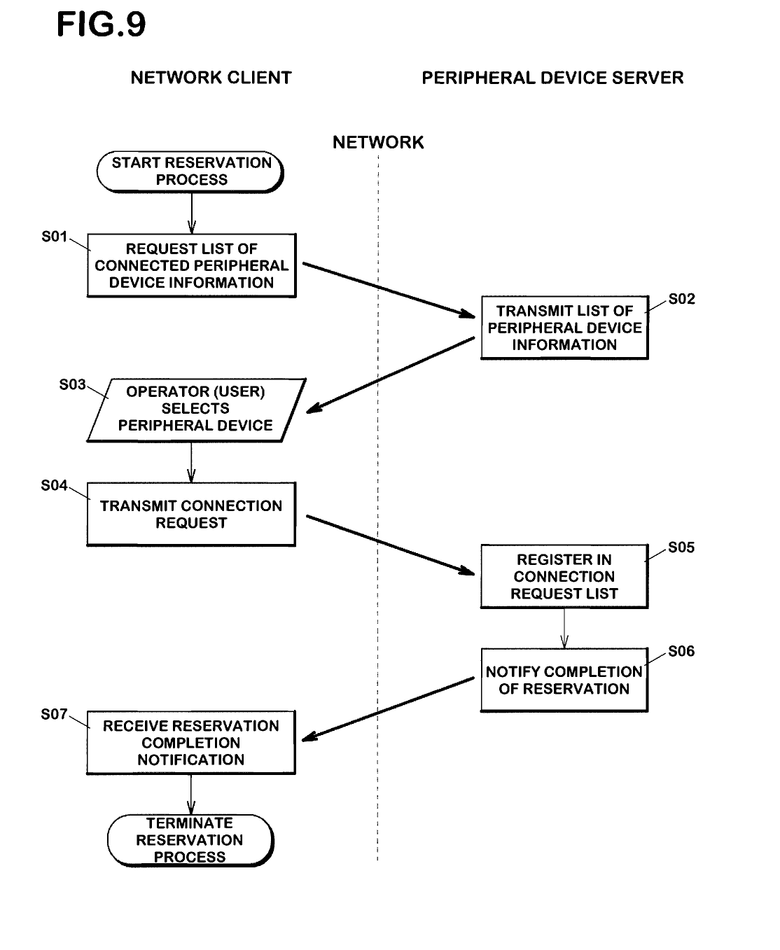

Detail of the reservation process is described with reference to FIG. 9.

The client program 40 of the network client 10n makes a request for a list of connected peripheral devices to the peripheral device server 1 (step S01 of FIG. 9). In response to such request, the peripheral device server 1 transmits the peripheral device information of the connected peripheral devices to the network client 10n (step S02). In this case, the list of peripheral device information as shown in FIG. 5 is transmitted.

After receiving the list of connected peripheral device information, the client program 40 of the network client 10n displays the list, and the operator (user) selects the desired peripheral device with reference to the list (step S03). In this case, FAX modem 120a is selected. After the selection is made by the operator (user), the client program 40 transmits a connection request specifying the peripheral device to which the connection request is made (step S04).

The server program 30 of the peripheral device server 1 adds the IP address and the requested time of the network client 10n, from which connection request was made, to the connection request list for the peripheral device specified in the connection request (step S05). The connection request list is thus changed from FIG. 6A to FIG. 6B. Specifically, the status “waiting for connection”, the IP address “aa.bb.cc.yy” of the network client 10n and the requested time “12/15 17:03” are stored with respect to the port “DEV01” to which the FAX modem 120a is connected. After registering to the connection request list, the server program 30 of the peripheral device server 1 transmits the reservation completion notification (step S06 of FIG. 9). The client program 40 of the network client 10n terminates the reservation process after receiving the reservation completion notification (step S07).

### 5.2 Connection Management Process

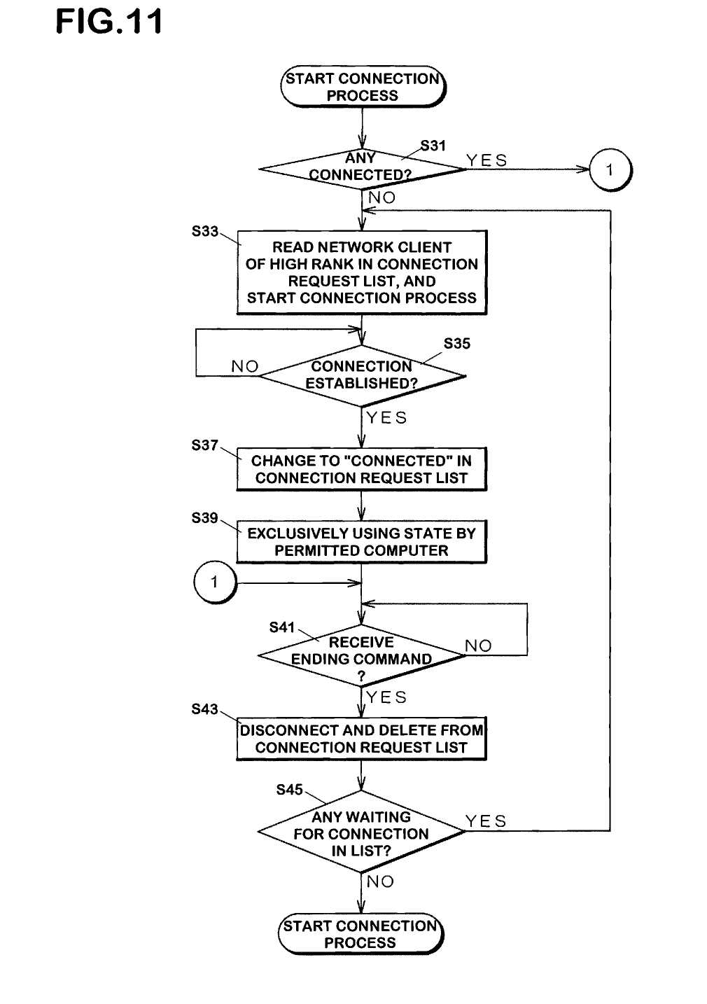

The connection management process is now described with reference to FIG. 11. The peripheral device server 1 manages the connection process of one or more network clients 10a to 10n and the peripheral device by means of the server program 30.

The server program 30 determines whether or not the connected network client is present (step S31). Specifically, determination is made whether or not the network client having the status “connected” is present in the connection request list. In the case shown in FIG. 6B, the “connected” network client is present, and thus determination is made whether or not an ending command is received from the network client having the IP address “aa.bb.cc.xx” (step S41). If the connection with a certain network client is permitted for a certain peripheral device, the network client of the next connection rank cannot establish a connection until the ending signal is provided from the relevant network client, and thus is in the waiting state. The ending signal is provided from the client program 40 of the network client having the IP address “aa.bb.cc.xx” to the server program 30 of the peripheral device server 1, as shown in FIG. 10. The server program 30 then gives a command to perform the disconnection process to the communication driver 32 via the control program 35. The communication driver 32 then disconnects the connection with the network client.

When the disconnection process with the network client having the IP address “aa.bb.cc.xx” is terminated, the server program 30 releases the exclusively using state of the FAX modem 120a by the network client, and deletes the IP address of the relevant network client from the connection request list (step S43). In this case, the IP address “aa.bb.cc.xx” is deleted from the connection request list of FIG. 6B. The connection request list is thus changed to FIG. 6C.

The server program 30 then determines whether or not reservation waiting for connection is present in the connection request list (step S45). In this case, the port DEV01 is being reserved by the network client having the IP address “aa.bb.cc.yy” with the status “waiting for connection” (see FIG. 6C), and thus the server program 30 reads the reservation of high rank in the connection request list. Since the reservation of the next rank is the IP address “aa.bb.cc.yy”, the server program 30 starts the connection process on the relevant network client (network client 10n) (step S33). The connection process is started by the communication driver 32 when the server program 30 gives a command to the communication driver 32 via the control program 35 (processes P05, 06, 07 of FIG. 10). The connection process of the communication driver 32 and the virtual USB port driver 43 is performed by TCP/IP communication.

The server program 30 thereafter determines whether or not connection is established with the network client having the IP address “aa.bb.cc.yy” (in this case, network client 10n) (step S35 of FIG. 11), and when connection is established, the status in the connection request list is changed to “connected” (step S37). The connection request list is changed to FIG. 6D.

The server program 30 makes the functional port connected with the FAX modem 120a in the exclusively using state (step S39 of FIG. 11), where can use FAX modem 120a exclusively by the network client 10n that has been given permission.

The process of the network client 10n is described below. Data communication is started in the network client 10n in the following manner. The client program 40 makes a connection request to the peripheral device server 1, and after receiving the reservation completion notification, outputs data from the application program 41 to the device driver 42 (process P08 of FIG. 10). The device driver 42 converts the relevant data to the predetermined format demanded by the FAX modem 120a, and makes an inquiry to transmit the converted data. The virtual USB port driver 43 cannot receive the data from the device driver 42 until after being subjected to the connection process from the communication driver 32, and thus does not respond to the inquiry. After the connection process is established by the communication driver 32 in this state, the virtual USB port driver 43 responds to the inquiry from the device driver 42, receives the relevant converted data (process P09), and transmits the same to the peripheral device server 1 as the TCP encapsulated data (process P10).

The communication driver 32 of the peripheral device server 1 sends the received data to the FAX modem 120a via the control program 35. That is, data is provided from the communication driver 32 to the control program 35 (process P11), from the control program 35 to the USB port driver 36 (process P12), and then from the USB port driver 36 to the FAX modem 120a (process P13). The communication is thus carried out between the network client 10n and the FAX modem 120a. The FAX modem 120a starts FAX transmission to the specified destination.

The communication between the virtual USB port driver 43 and the communication driver 32 is carried out by exchanging encapsulated packets for every predetermined amount of data. One transfer is completed when the control packet is sent from the network client 10n via the virtual USB port driver 43, and the response packet is returned from the peripheral device server 1 via the communication driver 32. The communication driver 32 and the virtual USB port driver 43 repeat the transfer of such encapsulated packets.

Therefore, data communication is carried out between the virtual USB port driver 43 of the network client 10n and the communication driver 32 of the peripheral device server 1. Since the data communication is carried out by encapsulating the data converted by the device driver 42 in the network protocol by the virtual USB port driver 43, the device driver 42 simply needs to perform the process similar to the process of sending data to the FAX modem directly connected to the local USB port. In other words, the FAX modem 120a appears as if directly connected to the local USB port by the network client 10n.

The data between the network client 10n and the FAX modem 120a is not sent from the virtual USB port driver 43 to the communication driver 32 as it is, but is sent after being performed with data conversion process once in the device driver 42 for FAX modem 120a on the network client 10n side. Thus, data can be communicated even if the device driver for FAX modem 120a is not installed in the peripheral device server 1.

The terminating process of the data communication is now described. The client program 40 makes a disconnection request to the server program 30 (process P20). The server program 30 transmits a response thereto (process P21). The server program 30 gives a command to perform the disconnection process to the communication driver 32 via the control program 35 (processes P22, P23). When receiving the command, the communication driver 32 performs the process of disconnecting the data communication with the virtual USB port driver 43 (process P24). A trigger for the client program 40 to issue the disconnection request to includes giving a command to the client program 40 to make a disconnection request through the operation of the operator (user), but is not limited thereto.

The terminating process of the data communication may be performed with a different method. Since the communication driver 32 can detect whether or not all the data converted by the device driver 42 have been sent, the communication driver 32 may perform the disconnection process after the detection.

In the present embodiment, list acquiring request/response (P01, P02), connection request/response (P03, P04) and disconnection request/response (P20, P21) are transmitted and received using the UDP/IP communication. The connection process (P07), the data transfer process (P10), and the disconnection process (P24) between the virtual USB port driver 43 and the communication driver 32 are performed using the TCP/IP communication. When the disconnection request is transmitted from the client program 40 to the server program 30 as the ending signal using the UDP/IP communication, the server program 30 commands the communication driver 32 via the control program 35 to perform the process of disconnecting the connection. The communication driver 32 performs the process of disconnecting the connection using the TCP/IP communication (P24). The exclusively using state between the network client 10n and the FAX modem 120a is released in this manner.

After the disconnection process is performed, the server program 30 deletes the relevant reservation from the reservation list (step S43 of FIG. 11). The server program 30 then determines whether or not reservation for waiting for connection is present in the connection request list (step S45 of FIG. 11). In this case, waiting for connection is not present, as shown in FIG. 6D, and thus the server program 30 terminates the connection process.

The process of terminating the communication is performed by issuing the disconnection request from the client program 40 in the present embodiment, but the communication driver 32 of the peripheral device server 1 may monitor the non-communicating state and provide a disconnecting command to the virtual USB port driver 43 if the non-communicating state has continued for a predetermined time or longer. The peripheral device thus can be released even if the disconnection request is not issued from the client program 40. According to such configuration, the peripheral device can be effectively utilized even if the network client does not release the peripheral device by automatically releasing the peripheral device at a predetermined time. Furthermore, the duration time how long the non-communicating state must be continued until disconnection can be performed may be arbitrary determined.

A case where the FAX modem 120a is connected by another network client has been described in the present embodiment, but if not connected at all, connection is immediately started after the reservation. If a plurality of network clients is waiting for connection, the connection process is sequentially performed from the highest connection rank. In the present embodiment, the connection rank corresponds to the connection requested time starting from the earliest, but other than such, priority may be set.

The connection request list stored in the peripheral device server 1 may be transmitted to the network client. Information such as using status, waiting list, and the like can be provided to the operator (user). The network client using the peripheral device is thus able to know the presence of the network client waiting for release and can rapidly release the peripheral device after use, whereby the peripheral device can be efficiently shared in the network.

6. Other Embodiments

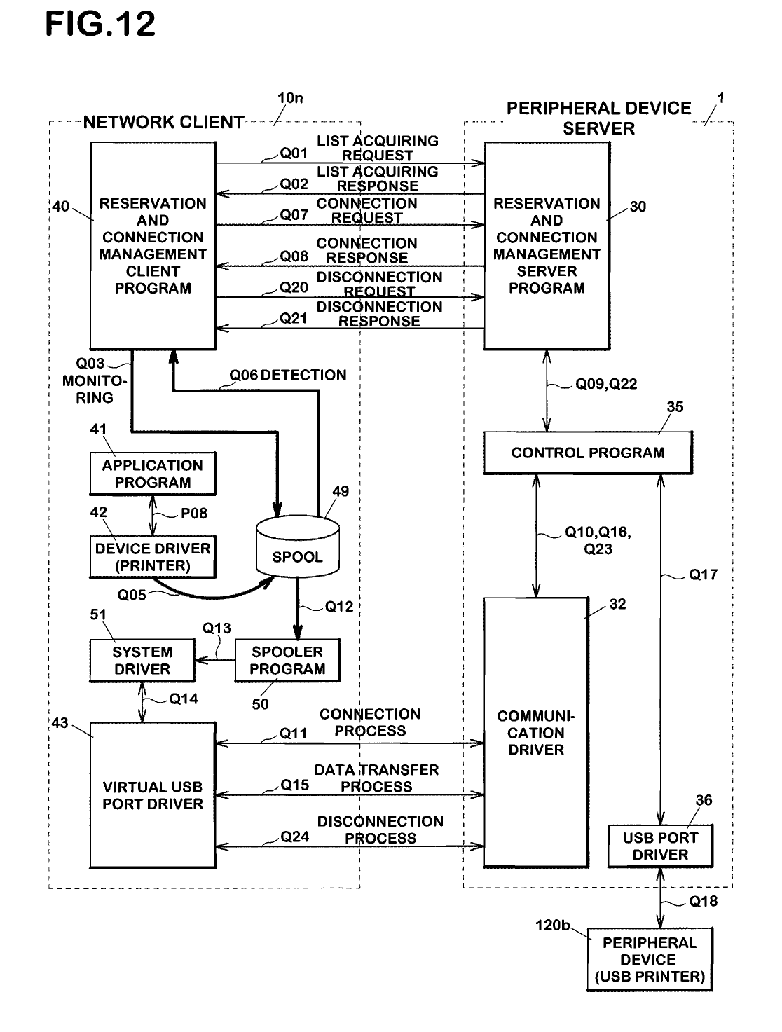

SPOOL (Simultaneous Peripheral Operation On-Line) for accumulating the data to the peripheral device is arranged on some peripheral devices. For instance, the USB printer is the case. The process in such a case is described using FIG. 12. A case where print data is sent from the application program 41 to the USB printer 120b is described below. In this case, a configuration thereof is the same as that in FIG. 10 except that the device driver 44 is for the USB printer 120b in the network client 10n and a SPOOL area 49, a spooler program 50, and a system driver 51 are arranged. The SPOOL area 49 may be arranged on the hard disc 26 or the like.

Whether or not the SPOOL area 49 is prepared for the peripheral device is determined by classification number of the interface class ID of the peripheral device.

The process of the client program 40 to acquire the list of peripheral device information from the server program 30 based on the command from the application program 41 is the same as the above embodiment, and thus is not repeated (processes Q01, Q02 of FIG. 12).

The operator (user) of the network client 10n selects the USB printer 120b with reference to the list, whereby print command is provided from the application program 41. The application program 41 sends the data to the device driver 44 for USB printer 120b regardless of whether or not the USB printer 120b can be used. The device driver 44 receives the data (process Q04), develops the same to print description language for the printer, and creates print job data on the SPOOL area 49 (process Q05).

The client program 40, on the other hand, monitors whether or not the print job data of the USB printer 120b exists in the SPOOL area 49 (process Q03), and when detecting the existence (process Q06), makes a connection request to the peripheral device server 1 (process Q07). The reservation process when connection request is made is the same as the above embodiment, and thus the explanation thereof is not repeated.

Similar to the above embodiment, when the USB printer 120b is in a usable state by the network client 10n, the server program 30 performs connection process to the virtual USB port driver 43 of the network client 10n by way of the control program 35 and the communication driver 32. The relevant process is the same as the above embodiment, and thus the explanation thereof is not repeated.

The spooler program 50 of the network client monitors whether or not the print job data of the USB printer 120b exists in the SPOOL area 49, and when detecting the existence (process Q12), sends the data to the system driver 51 (process Q13). The system driver 51 that has received the data then sends the data to the virtual USB port driver 43 (process Q14). Since the connection process with the communication driver 32 is already performed, the virtual USB port driver 43 starts the data transfer process (process Q15). The communication driver 32 of the peripheral device server 1 receives the data and sends the data to the control program 35 (process Q16), and the control program 35 transmits (process Q18) the data to the USB printer 120b or the peripheral device via the USB port driver 36 (process Q17). The USB printer 120b performs printing based on the received data.

Regarding the disconnection process, the client program 40 monitors the SPOOL area 49, and issues the disconnection request when data no longer exists. The process after the disconnection request is issued is the same as the above embodiment, and thus the description thereof is not repeated.

Therefore, when the peripheral device is a USB printer, and SPOOL is set in the network client, the operator (user) of the network client simply needs to store the data in the SPOOL to automatically perform connection/disconnection control between the client program and the server program, and the operator (user) does not need to again command the client program to issue the connection request and the disconnection request, whereby convenient and efficient operation for the operator (user) is realized.

If a plurality of printer drivers exists, determination must be made on which SPOOL area corresponds to the relevant printer driver. This can be determined by referencing the correspondence information stored in the reservation and connection management client program when installing each printer driver.

In the above embodiment, determination is made on whether or not data for peripheral device is present in the SPOOL area, and if present, computer identifier of the network client is stored in the reservation list of the peripheral device server, and the peripheral device server permits the use of the peripheral device to the network computer that has made the use request when the connecting rank of the network computer that has made the use request is reached with reference to the reservation list. However, such reservation process is arbitrary, and permission may be requested without the reservation process. That is, the network computer monitors whether or not the data for peripheral device is present in the SPOOL area, and if present, may ask the peripheral device server for permission to use the peripheral device. The peripheral device server gives permission to use the peripheral device if it is available. Therefore, data output process does not need to be waited until the data output is permitted by using the SPOOL area since the permission to use is requested to the peripheral device server when the application program starts writing to the relevant SPOOL area.

In the description of the embodiments of the present invention, UDP/IP communication and TCP/IP communication are used as the communication protocol, but the communication protocol is not limited thereto. Various means and protocols in the computer communication may be applied.

USB is described for the interface between the peripheral device server and the peripheral device, but is not limited thereto. The present invention may also be applied to IEEE 1394 standard and the like.

In data communication, the communicating data portion may be encrypted for communication. The peripheral device then may be safely and remotely operated while ensuring secure communication, and sentences in print data etc. not desiring to be seen may be printed or faxed.

A case of data transmission from the network client 10n to the peripheral device server 1 as in printer output has been described, but similar application is also possible to a case where processing command is provided from the network client and data is transmitted from the peripheral device server 1 according to the process command, for example, when USB connected Web camera is the peripheral device. In this case as well, after communication is established between the Web camera and the network client, data is transmitted from the Web camera in response to the request from the network client. The device driver for the Web camera is merely installed in the network client.

In addition, the peripheral device to which the system according to the present invention can be applied includes, other than the printer and the FAX modem, various USB devices (target devices) such as a scanner, a storage (hard disc, USB memory), an IC card read writer, an optical drive such as a CD/DVD drive, a fingerprint authentication unit, a speaker, a Web camera, a TV capture unit, a multifunction printer (multifunction peripherals), a game PAD, a flexible disc drive, a mouse, and a keyboard. There are two types of USB device; one is a host device that controls the device, the other is a target device that is to be controlled. The host device is the peripheral device server of the present invention or the personal computer, for example.

Therefore, a system in which the peripheral device is more efficiently shared in the network is obtained by adding a function in which the peripheral device server provides the connection request list (name of peripheral device, connection/release status, requested time, IP address of network client requesting connection), an automatic disconnection function for releasing the peripheral device, etc. to the tunneling technique in which the network client present in the network where the peripheral device server is being used pseudo-represents the peripheral device connected to the peripheral device server by way of the network as the peripheral device connected to the local bus of the network client.

The USB device only having a single USB I/F such as multifunction printer (multi-function peripherals, hereinafter abbreviated as MFP) with a plurality of functions of printer/scanner/FAX/storage including a function configured by a plurality of peripheral device parts (peripheral function parts) such as printer part, scanner part, FAX part, storage part and the like exists. When such peripheral device is connected to the peripheral device server, each function part is recognized as if an individual USB device. In the relevant multifunction peripheral, malfunction may occur if the use request is made to the different function parts from different users and the use request is provided to the multifunction peripherals. This is because the multifunction peripherals is assumed to be directly connected to the computer to be used, and control is determined under the assumption that control command is not provided in parallel from the plurality of computers. Malfunction obviously occurs when the function part requested for use partially overlaps, but also when the function part does not overlap. In order to overcome such problem, the multifunction peripherals should be recognized as one device for every logic port and for every functional port.

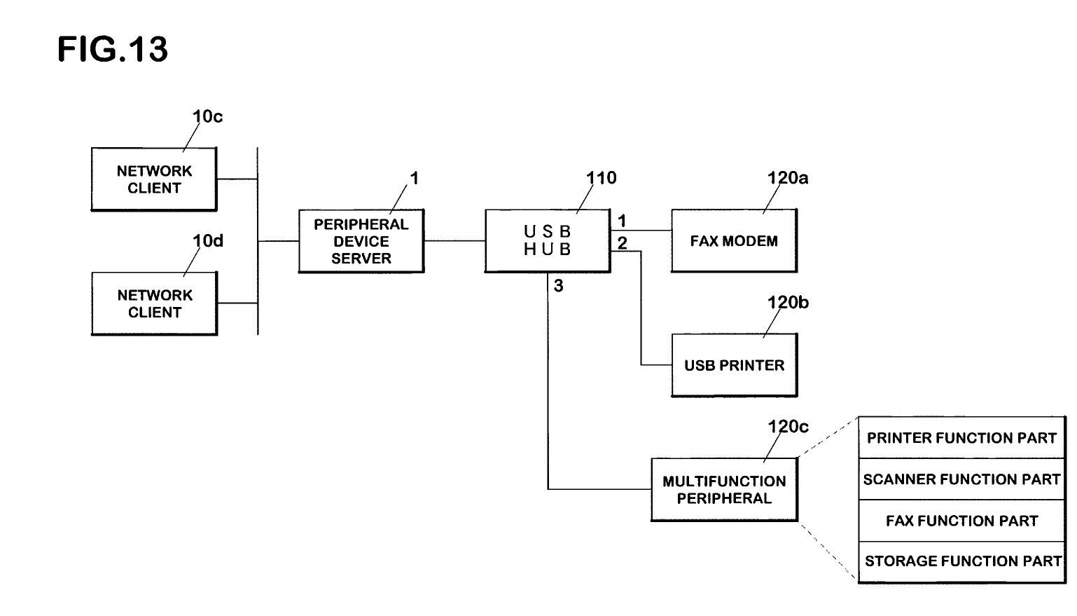

A case where the plurality of network clients, the peripheral device server, and the peripheral device are connected as in FIG. 13 is now described. In FIG. 13, the network clients 10c, 10d and the peripheral device server 1 are connected via the network, and furthermore, the fax modem 120a, the USB printer 120b, and the multifunction peripheral 120c are connected to the peripheral device server 1 by way of the USB hub 110. The multifunction peripheral 120c includes a printer function part, a scanner function part, a FAX function part, and a storage function part.

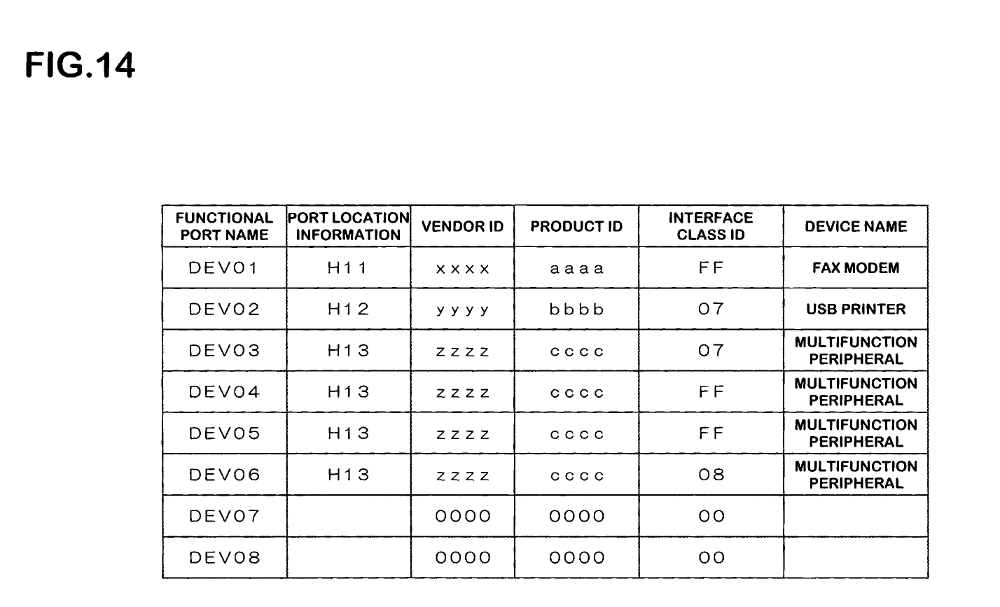

The peripheral device information in this case is shown in FIG. 14. Compared to FIG. 5, port location information is added in FIG. 14. The port location information describes the port identification number in order from the peripheral device server side. “H13” is described in the port location information for the functional ports DEV03 to 06 to which the multifunction peripheral is connected. The “H” at the front indicates connection speed of the USB (H refers to High speed). The next two digit numbers “13” indicate the port number “1” where the peripheral device server 1 and the USB hub 10 are connected and the third port of the USB hub 110.

The fax modem 120a and the USB printer 120b are connected to the first and second ports of the USB hub 110, and thus the port location information are described as “H11” and “H12”.

The device name of the multifunction peripheral 120a is “multifunction peripheral”.

The reservation process is substantially the same as the first embodiment. That is, when request for the list is made, the peripheral device server 1 transmits the peripheral device information (see FIG. 14) of the connected peripheral devices to the network client in step S02 of FIG. 9. After receiving the list of the connected peripheral device information, the client program 40 of the network client displays the list, so that the operator (user) can select the desired peripheral device with reference to the list (step S03). In this case, the operator selects the multifunction peripheral 120c. When selection is made from the operator, the client program 40 transmits a connection request in which the peripheral device, to which request for the connection is made, is specified (step S04). The operator then recognizes as one device not for every functional port but for the devices having the same port location information, and makes a reservation.

The connection management process is substantially the same as the first embodiment, but differs in that the functional ports having the same port location information are treated as one collective device.

Therefore, the server program 30 has all the functional ports having the same port location information of the multifunctional peripherals in the exclusively using state by the network client when setting the exclusively using state by the permitted network client in step S39. Obviously, all the functional ports having the same port location information of the multifunction peripherals are disconnected in the process in step S43.

The connection process between the virtual USB port driver and the communication driver is performed with the assumption that a plurality of USB devices is being connected. In the case of multifunction peripheral 120c, when connection request is made by the user, four connections of the printer function part (Dev03), the scanner function part (Dev04), the FAX function part (Dev05), and the storage function part (Dev06) are simultaneously established from one client. In disconnection, the four connections are simultaneously disconnected.

Therefore, the reservation process can be performed without malfunctioning even in the multifunction peripheral where connection to the network is not a presumption by collectively performing reservation, exclusive use, and release processes for all functional ports when connecting to the peripheral device server 1.

According to the present invention, when a use request is made for a certain peripheral device, registration to the reservation list is performed, and the server program of the peripheral device server controls the connection according to the reservation list. The peripheral device server then gives the controlling right of the peripheral device in the order the operator (user) of the network client has made the connection request. Therefore, the peripheral device that cannot communicate with other network clients once started to be used by a certain network client unless such use is released such as the USB device can be effectively used.

According to the present invention, after data conversion by the device driver of the peripheral device to use is performed in the network client, network transmission is performed to the peripheral device server to send the data to the peripheral device. The device driver of the connected peripheral device is thus not necessary in the peripheral device server. Generally, the provider of the peripheral device provides the device driver corresponding to each computer for each peripheral device. Therefore, if the device driver is to be installed to the peripheral device server, the device driver that complies with the hard ware construction of the peripheral device server must be newly produced. In the present invention, however, the device driver for peripheral device connected to the peripheral device server does not need to be installed if the device driver of the peripheral device desired to be used is installed in each network client. The device driver does not need to be installed in the peripheral device server because data is converted by the device driver for peripheral device to use before being output to the virtual USB port driver, and thereafter, data transmission is performed between the virtual USB port driver and the communication driver to transmit data between the network client and the peripheral device.

According to the present invention, the length of the USB cable is limited, but limitation in terms of distance is eliminated through the use of the network, and thus the peripheral device positioned at a remote location may be used.

According to the present invention, since the data communicated between the network client and the peripheral device can be data communicated on the network by being subjected to encapsulating process by the virtual USB port driver and the communication driver, the device driver for peripheral device installed in the network client does not need to be aware of transmitting the data on the network, and thus the peripheral device that can not be connected to the network can be shared on the network.

The reservation and connection management server program 30 of the peripheral device server 1 is stored in the flash memory in advance in the description of the embodiment of the present invention, but may be downloaded via the communication controller 24.

In the description of the embodiment in the present invention, the CPU is used to realize the functions shown in FIG. 2, which are realized by software. However, it may be partially or entirely realized by hardware of logic circuit etc.

One part of the process of the program may be performed by operating system (OS).

While preferred embodiments of the invention have been described, such description is for illustrative purposes only, and it is to be understood that changes and variations may be made without departing from the spirit or scope of the following claims.

1-17. (canceled)

18. A peripheral device using method for a network computer connected via a network to a peripheral device server to use a peripheral device, the method comprising:
A) the peripheral device server storing a computer identifier of the network computer in a reservation list when a use request in which the connected peripheral device is specified is made from the network computer;
B) the peripheral device server specifying a network computer of a high rank with reference to the reservation list, and permitting the network computer to start using the peripheral device;
C) the permitted network computer starting data communication to the peripheral device;
D) the peripheral device server providing received data for the peripheral device to the peripheral device;
E) the peripheral device server transmitting the data received from the peripheral device to the permitted network computer, and the network computer receiving the data;
F) the network computer transmitting an ending command to the peripheral device server when the data communication with the peripheral device is ended;
G) the peripheral device server releasing use of the peripheral device by the network computer when receiving the ending command; and
H) repeating B) to G) steps if a network computer that has not yet used the connected peripheral device is present in the reservation list.

19. A peripheral device server connected with a peripheral device, the peripheral device server comprising:
A) reservation managing means for storing in a reservation list a computer identifier of one of the network computers connected via network when a use request in which the connected peripheral device is specified is made from the network computer; and
B) connection managing means including
b 1) releasing means for releasing use of the peripheral device by the network computer when receiving an ending command from the network computer having been using the peripheral device, and
b2) permitting means for determining whether or not a network computer that has not yet used the peripheral device is present in the reservation list when receiving the ending command, and if present, specifying a network computer of a high rank with reference to the reservation list and permitting the network computer to use the peripheral device.

20. The peripheral device server according to claim 19, wherein a data communicating means transmits data from the network computer to the peripheral device.

21. The peripheral device server according to claim 19, wherein a data communicating means transmits data from the peripheral device to the network computer.

22. The peripheral device server according to claim 19, wherein:
the peripheral device is configured as an assembly of a plurality of peripheral device parts;
each of the peripheral device parts is configured unable to communicate, once started to be used by a network computer unless released, with another network computer;
the reservation managing means stores, when a use request in which the connected peripheral device is specified is made from one of a plurality of the network computers connected via a network, a computer identifier of the network computer in the reservation list for all the peripheral device parts configuring the peripheral device that has made the use request;
the releasing means releases use of all the peripheral device parts by the network computer when receiving an ending command from the network computer that has been using the peripheral device;
the permitting means determines whether or not a network computer that has not yet used the peripheral device is present in the reservation list when receiving the ending command, and if present, specifies a network computer of a high rank with reference to the reservation list, and permits the network computer to use all the peripheral device parts of the peripheral device; and
the data communicating means provides, when receiving data for one or more peripheral device parts of the peripheral device from the permitted network computer, the data to the peripheral device.

23. A network computer connected via a network to a peripheral device server to be connected with a peripheral device; the network computer comprising:
reservation proposing means for making a use reservation on the peripheral device connected to the peripheral device server;
using means for, when receiving a notification that use is possible, transmitting data for the peripheral device and starting to use the peripheral device; and
end commanding means for transmitting an ending command to the peripheral device server to release use of the peripheral device by the network computer when use of the peripheral device is ended.

24. A recording medium storing a program for a network computer to execute processes with a peripheral device server connected with a peripheral device, the program for making the peripheral device server execute process steps comprising:
making a use reservation for the peripheral device connected to the peripheral device server;
transmitting data for the peripheral device when receiving a notification that use is possible, and starting to use the peripheral device; and
transmitting an ending command to the peripheral device server to release use of the peripheral device by the network computer when use of the peripheral device is ended.

25. A method of using a peripheral device by a network computer, for allowing a plurality of network computers connected via a network to access a peripheral device server connected with peripheral devices, and transmit and receive data with one of the peripheral devices, the method comprising:
storing in the peripheral device server a computer identifier and a rank of a network computer that has made a use request in which one of the peripheral devices is specified;
transmitting data for the peripheral device via the peripheral device server when use of the peripheral device by a network computer of a higher rank is ended and use of the peripheral device is permitted; and
providing an ending command when data transmission to the peripheral device is ended, and releasing use of the peripheral device by the network computer.

26. A data outputting method comprising the steps of:
connecting a peripheral device to a peripheral device server,
connecting the peripheral device server and network computers via a network, and
outputting data from one of the network computers to the peripheral device, each of network computers having a temporary storage area; wherein
the one of the network computers determines whether or not data for the peripheral device is present in the temporary storage area;
the peripheral device server gives the one of the network computers permission to use the peripheral device when the one of the network computers detects data for the peripheral device is present; and
the one of the network computers which is given the permission outputs the data stored in the temporary storage area to the peripheral device.

27. The data outputting method according to claim 26, wherein
the one of the network computers makes a disconnection request to the peripheral device server after outputting all the data for the peripheral device stored in the temporary storage area to the peripheral device; and
the peripheral device server releases use of the peripheral device by the one of the network computers when receiving the disconnection request.

28. The data outputting method according to claim 26, wherein
the one of the network computers sends the use request for the peripheral device to the peripheral device server when the one of the network computers detects data for the peripheral device is present; and
the peripheral device server gives the one of the network computers the permission to use the peripheral device when the peripheral device server receives the use request.

29. The data outputting method according to claim 26, wherein
the one of the network computers sends the use request for the peripheral device to the peripheral device server when the one of the network computers detects data for the peripheral device is present; and
the peripheral device server stores a computer identifier of one of the network computers in a reservation list in chronological order when the peripheral device server receives the use request in which the connected peripheral device is specified from the one of the network computers, and
the peripheral device server gives the one of the network computers permission to use the peripheral device when a turn comes for the one of the network computers in accordance with the reservation list.
